(19) United States
(12) Patent Application Publication
(10) Pub. No.: US 2014/0056429 A1
(43) Pub. Date: Feb. 27, 2014

(54) SPATIALIZATION USING STEREO DECORRELATION

(71) Applicant: Justin Lamar Allen, Mesa, AZ (US)

(72) Inventor: Justin Lamar Allen, Mesa, AZ (US)

(73) Assignee: QUICKFILTER TECHNOLOGIES, LLC, Allen, TX (US)

(21) Appl. No.: 13/595,086

(22) Filed: Aug. 27, 2012

(51) Int. Cl. H04S 5/00

(52) U.S. Cl. CPC H04S 5/00
USPC 381/17

(57) ABSTRACT

A method for spatialization using stereo decorrelation. The method generates decorrelated left and right signals by filtering the left input channel using an all-pass filter with a first group delay and filtering the right input channel using an all-pass filter with a second group delay; the second group delay being different than that of the first group delay. The decorrelated left signal is subtracted from the decorrelated right signal to create a second left signal and the decorrelated right signal is subtracted from the decorrelated left signal to create a second right signal. The method generates a side signal by adding the filtered left input channel signal and the filtered right input channel signal. The side signal is added to the second left signal to generate a left output signal the side signal is added to the second right signal to generate a right output signal.

### BACKGROUND

1. Technical Field

This disclosure relates to the creation of a stereo signal with enhanced perceptual quality, or spatialization; and in particular, to how a signal represented by a mid-signal and side-signals can be processed to create a stereo signal with improved characteristics.

2. Background

Recently, it has become feasible to store and playback larger amounts of music on portable devices. As a consequence, the use of such devices became very popular, especially as the musical content can be played back via headphones everywhere. Normally, the content to be played back has been mixed in stereo, i.e., to two independent channels. However, the production has been performed for a playback via loudspeakers, using common two-channel stereo-equipment. That is, the stereo-channels have been mixed in a music-studio such as to provide maximum reproduction quality, and, as far as possible, the spatial perception of the original auditory scene using two loudspeakers. However, listening to such stereo recordings via headphones leads to in-head localization of the sound; virtual sound sources, which are meant to be localized somewhere between the two loudspeakers, are localized inside the listener's head due to psychoacoustic properties of the human auditory system. This is the case since no crosstalk and no reflections are perceived.

Several methods and devices have been proposed to address this problem by processing the left and right channels prior to the playback via headphones. However, these approaches, as for example the use of head related transfer functions, are computationally very complex. These approaches try to stimulate the human auditory system to localize the sound sources outside the head when playing back music with headphones by simulating the listening situation of loudspeakers in a room. For example, a cross-talk sound path and the reflections of the room's walls may be artificially added to the signal. When fairly well-sounding results are to be received with reduced complexity, those models are, for example, reduced to cross-talk, and, in some cases, to a very small number of wall reflections, which can be implemented by low-order filtering

Often, stereo signals are also transformed in to a mid-side representation containing a mid-signal (sum-signal) and a side-signal (difference signal). The sum-signal is formed by summing up the right channel and the left channel and the difference signal is formed by building the difference of the left channel and the right channel. In most musical stereo-signals, the virtual sound sources of highest relevance are those localized in front of the listener. This is the case, since these commonly represent the leading voice or the leading instrument in the recording. As these sound sources are intended to be localized between the loudspeakers of a two-channel setup, these signal components are present in the left channel as well in the right channel. Therefore, these important signals are mainly represented by a sum-signal (mid-signal) and hardly by a different signal (side-signal). Therefore, when attempting to achieve a localization out of a listener's head, such a mid-side representation has to be processed with great care.

Given the conventional generation of stereo-signals and the changed playback habits, the need exists to provide a concept for the generation of a stereo signal with enhanced spatialization that can be efficiently implemented.

### DRAWINGS

FIG. 1 is a block diagram of a circuit for implementing an embodiment.

FIGS. 2A and 2B are exemplary plots of left and right group delay characteristics.

FIG. 3 is a block diagram of a circuit for implementing another embodiment.

### DETAILED DESCRIPTION

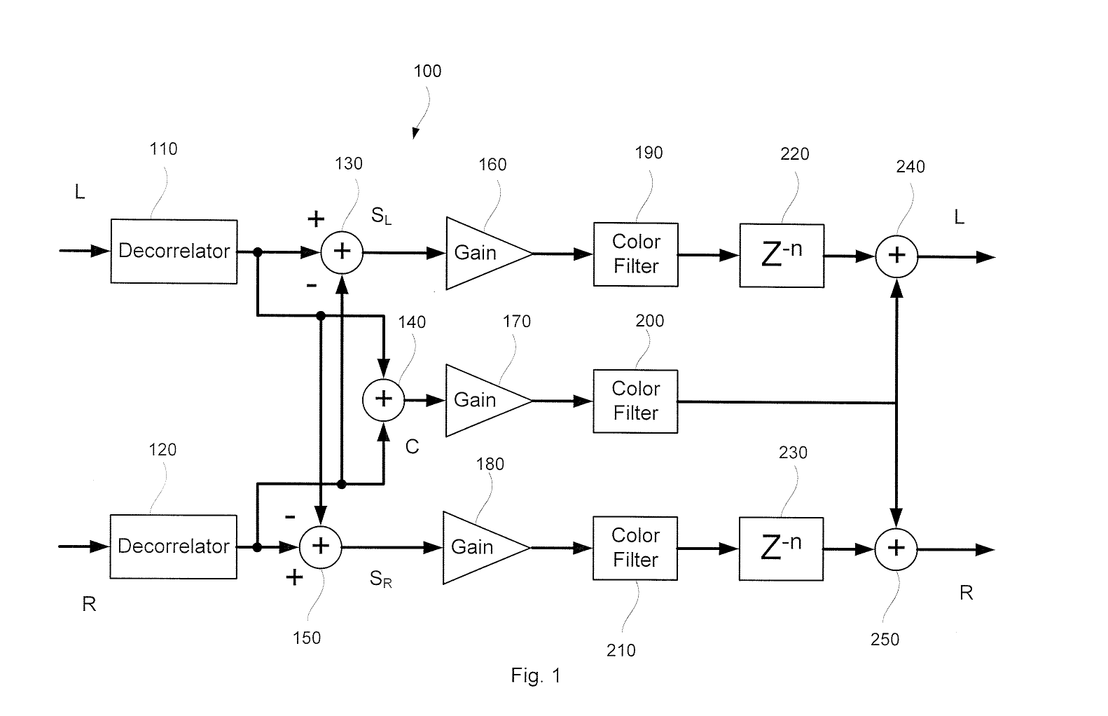

The method disclosed here can be logically divided into three parts. In the first part, the left and right signals are decorrelated to increase the differences between them. The rest of the method enhances those differences, so the more difference there is to begin with, the better the rest of the method will work. The second part of the method converts the left and right signals to a decorrelated side signal. The left and right and side signals are processed separately to further enhance the left and right signals compared to the side signal. Finally, the left and right and side signals are mixed to recreate the left and right stereo signals. FIG. 1 is a block diagram of a first embodiment of a circuit for implementing the disclosed method (100) for spatialization using stereo decorrelation. Each section is explained in the following paragraphs. The reader should note that the method could be implemented in software on a digital-signal processor, or a general-purpose programmable computer, or it could be implemented as a circuit in hardware, such as an integrated-circuit chip.

### First Embodiment

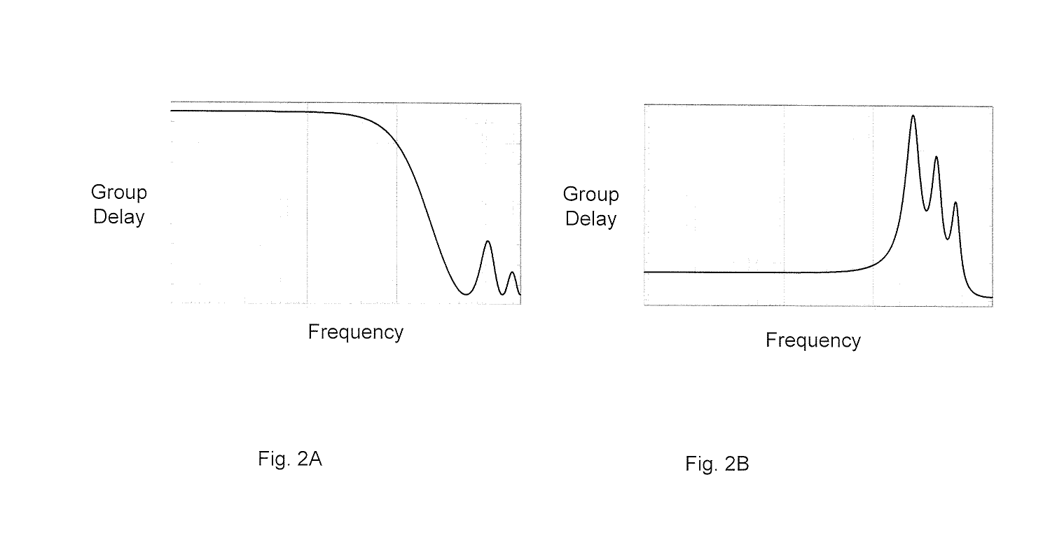

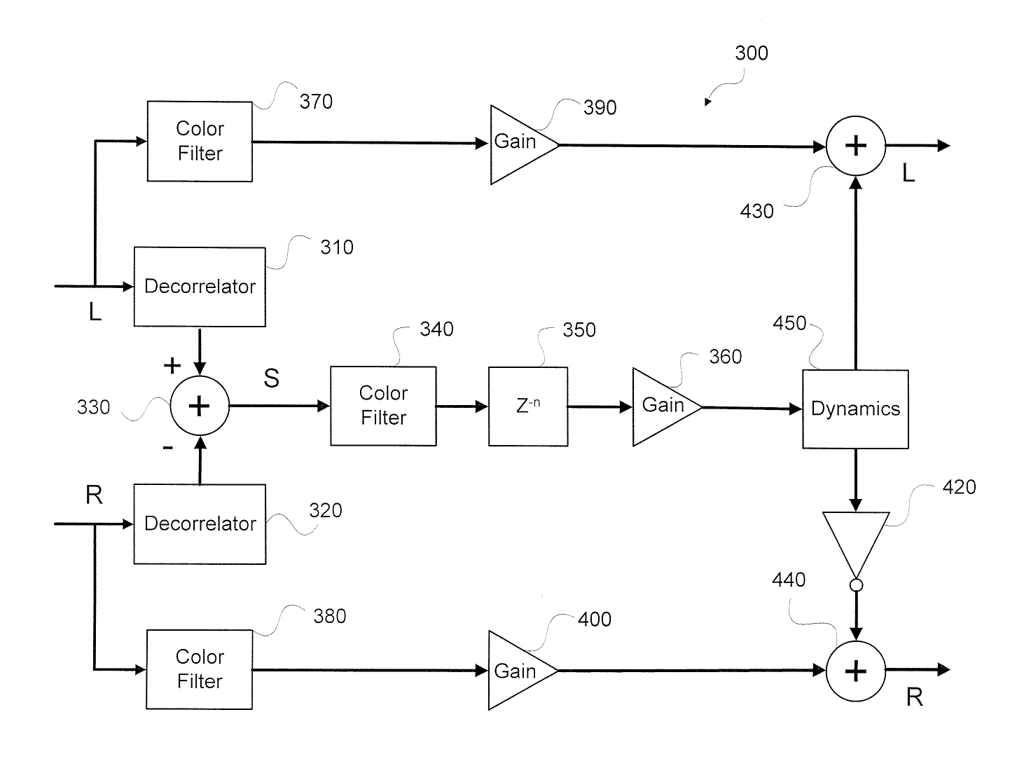

First, the left decorrelator block (110) and the right decorrelator block (120) increase the differences between the left and right signals so that the processing that follows is more effective. The decorrelator blocks (110, 120) are preferably sixth-order infinite-impulse response (IIR) all-pass filters with arbitrary group delay. By making the group delay characteristics different between the left decorrelator (110) and the right decorrelator (120), the difference between the left and right signals is enhanced as the signals are passed through the decorrelators (110, 120). Since the filters are all-pass, the frequency responses of the left and right signals are not changed. FIGS. 2A and 2B shown typical group delay plots that would result from implementation of the left decorrelator (110) and the right decorrelator (120) with different group delay characteristics. The plots shown are exemplary only, and somewhat different plots would result with different decorrelation filters.

The IIR filters provide an efficient decorrelation filter, but the decorrelation can be improved by using finite-impulse-response (FIR) filters. The phase characteristic can be better controlled in FIR filters, so that a perfect decorrelation can be achieved if the filters are long enough and carefully designed. But even relatively short decorrelation filters, on the order of 15 taps can be used to achieve very good results.

After the left and right signals are decorrelated, the left and right and side signals are calculated as shown in FIG. 1. The right signal (R in the figure) is subtracted from the left signal (L in the figure) in the first adder (130). The left signal is subtracted from the right signal in the second adder (150). The left and right signals from the decorrelator blocks (110, 120 are added together in a third adder (140) to create the side signal (S in the figures).

After the left and right and side signals are created, they are independently gained. The left and right signals would typically be gained more than the side signal. This enhances the left and right signals compared to the side signal, making the stereo content more easily heard.

Next, the signals are colored independently in color filters, preferably using second-order IIR filters. The left and right signals would typically have their high frequencies enhanced using shelf filters or even high-pass filters (190, 210). The side signal would typically have its low frequencies enhanced using a shelf or low-pass filter (200). The ear determines spatial location using high frequencies, so enhancing those frequencies on the left and right signals should increase the spatial sense. Enhancing the low frequencies of the side signal ensures that the bass response of the complete audio is maintained.

Finally, a delay (220, 230) can be optionally added to the left and right signals. These delays (220, 230) are meant to emulate the delay caused when sound from the side of the head arrives at each ear at different times. The delay would typically be about 0.5 milliseconds.

After the left and right and side signals have been thus enhanced, the left and right stereo channels are recreated using: L=L+S and R=R−S in fourth and fifth adders (240, 250) as shown in FIG. 1.

### Second Embodiment

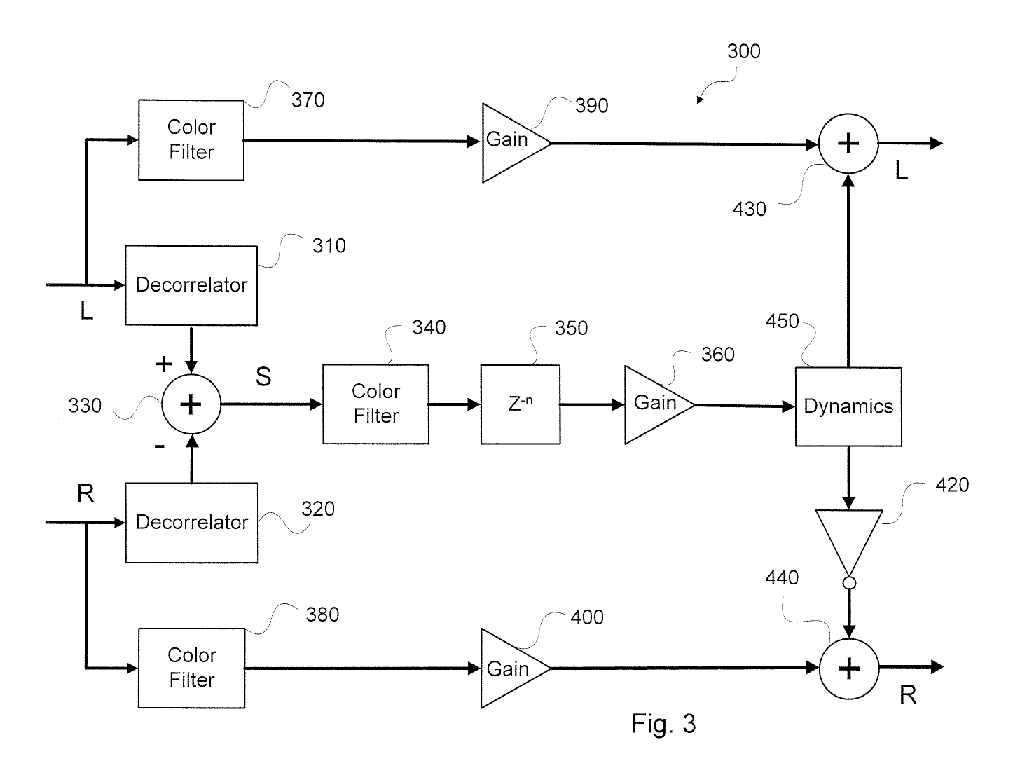

In a second embodiment (300), the components of the circuit are re-arranged as shown in FIG. 3. The second embodiment (300) is mathematically equivalent to the first embodiment (100), but is computationally more efficient.

In the second embodiment (300), the output of the right decorrelator (320) is subtracted in adder (330) from the output of the left decorrelator (310). The side signal S thus created is passed through a first color filter (340) as described above in the discussion of the first embodiment (100). The side signal is passed through a delay block (350) for the purposes also discussed above and independently gained in a first gain block (360). The left and right channels, bypassing decorrelation, are passed through second and third color filters (370, 380) as described in the discussion of the first embodiment (100) and independently gained in second and third gain blocks (390, 400).

The side signal is added in a second adder (430) to the separately colored and gained left signal to recreate the left stereo channel. The side signal is inverted in an inverter (420) and added in a third adder (440) to the separately colored and gained right signal to recreate the right stereo channel.

The gain of the side channels can be automatically controlled by an optional dynamic processing block (450) that maintains the gain relationship between the main signal and the side signal. The Dynamic Processing block analyzes the energy of the side signal and main signal and varies the gain of the side signal accordingly. The DP block works like an AGC, increasing the gain of the side signal when the energy is low, and decreasing the gain when the energy is high. The DP block allows the spatialization method to work with many different types of music.

The reader will see that the methods disclosed can be tuned to specific applications by varying the gain, filtering and delay characteristics of the various components shown, all of which implementations are intended to be covered by the claims.

None of the description in this application should be read as implying that any particular element, step, or function is an essential element which must be included in the claim scope; the scope of patented subject matter is defined only by the allowed claims. Moreover, none of these claims are intended to invoke paragraph six of 35 U.S.C. Section 112 unless the exact words “means for” are used, followed by a gerund. The claims as filed are intended to be as comprehensive as possible, and no subject matter is intentionally relinquished, dedicated, or abandoned.

I claim:

1. A method for spatialization using stereo decorrelation, in an audio system having left and right input channels, the method comprising:
generating decorrelated left and right signals by:
filtering the left input channel using an all-pass filter with a first group delay;
filtering the right input channel using an all-pass filter with a second group delay; the second group delay being different than that of the first group delay;
subtracting the decorrelated left signal from the decorrelated right signal to create a second left signal;
subtracting the decorrelated right signal from the decorrelated left signal to create a second right signal;
generating a side signal by adding the filtered left input channel signal and the filtered right input channel signal;
adding the side signal to the second left signal to generate a left output signal; and,
adding the side signal to the second right signal to generate a right output signal.

2. The method of claim 1 further comprising applying gain to the second left and right signals, and the side signal.

3. The method of claim 2 where the gain applied to the side signal is greater than the gain applied to either of the second left and second right signals.

3. The method of claim 1 further comprising filtering the second left and second right signals to enhance high frequencies, and filtering the side signal to enhance low frequencies.

4. The method of claim 1 further comprising adding a delay to the second left and second right signals before the side signal is added to the second left and second right signals to generate the right output signal and the left output signal.

5. A method for spatialization using stereo decorrelation, in an audio system having left and right input channels, the method comprising:
generating decorrelated left and right signals by:
filtering the left input channel using an all-pass filter with a first group delay;
filtering the right input channel using an all-pass filter with a second group delay; the second group delay being different than that of the first group delay;
subtracting the decorrelated left signal from the decorrelated right signal to create a second left signal;
subtracting the decorrelated right signal from the decorrelated left signal to create a second right signal;
generating a side signal by adding the filtered left input channel signal and the filtered right input channel signal;
applying gain to the second left and right signals, and the side signal; where the gain applied to the side signal is greater than the gain applied to either of the second left second right signals;
filtering the second left and second right signals to enhance high frequencies, and filtering the side signal to enhance low frequencies;
adding the side signal to the second left signal to generate a left output signal;
adding the side signal to the second right signal to generate a right output signal; and,
adding a delay to the second left and second right signals before the side signal is added to the second left and second right signals to generate the right output signal and the left output signal.

6. A method for spatialization using stereo decorrelation, in an audio system having left and right input channels, the method comprising:
generating decorrelated left and right signals by:
filtering the left input channel using an all-pass filter with a first group delay;
filtering the right input channel using an all-pass filter with a second group delay; the second group delay being different than that of the first group delay; and,
subtracting the decorrelated right signal from the decorrelated left signal to create a side signal.

7. The method of claim 6 further comprising filtering the left and right input channels to enhance high frequencies and filtering the side signal to enhance low frequencies.

8. The method of claim 7 further comprising applying gain to the left and right input channels.

9. The method of claim 6 further comprising adding a delay to the side signal.

10. The method of claim 6 further comprising applying gain to the side signal, where the gain applied to the side signal is greater than the gain applied to either of the left and right input channels.

11. The method of claim 6 further comprising:
adding the side signal to the left input channel to recreate a left stereo channel;
inverting the side signal; and,
adding the inverted side signal to the right input channel to recreate a right stereo signal.

12. A method for spatialization using stereo decorrelation, in an audio system having left and right input channels, the method comprising:
generating decorrelated left and right signals by:
filtering the left input channel using an all-pass filter with a first group delay;
filtering the right input channel using an all-pass filter with a second group delay; the second group delay being different than that of the first group delay;
subtracting the decorrelated right signal from the decorrelated left signal to create a side signal;
filtering the left and right input channels to enhance high frequencies and filtering the side signal to enhance low frequencies;
applying gain to the left and right input channels;
adding a delay to the side signal;
applying gain to the side signal, where the gain applied to the side signal is greater than the gain applied to either of the left and right input channels;
adding the side signal to the left input channel to recreate a left stereo channel;
inverting the side signal; and,
adding the inverted side signal to the right input channel to recreate a right stereo signal.

13. An article of manufacture comprising a computer-readable medium having computer-executable instructions for performing a method of spatialization using stereo decorrelation, in an audio system having left and right input channels, the method comprising:
generating decorrelated left and right signals by:
filtering the left input channel using an all-pass filter with a first group delay;
filtering the right input channel using an all-pass filter with a second group delay; the second group delay being different than that of the first group delay;
subtracting the decorrelated left signal from the decorrelated right signal to create a second left signal;
subtracting the decorrelated right signal from the decorrelated left signal to create a second right signal;
generating a side signal by adding the filtered left input channel signal and the filtered right input channel signal;
adding the side signal to the second left signal to generate a left output signal; and,
adding the side signal to the second right signal to generate a right output signal.

14. The article of manufacture of claim 13 where the method further comprises applying gain to the second left and second right signals, and the side signal.

15. The article of manufacture of claim 14 where the method further comprises adding gain to the side signal such that the gain added is greater than the gain applied to either of the second left and second right signals.

16. The article of manufacture of claim 13 where the method further comprises filtering the second left and second right signals to enhance high frequencies, and filtering the side signal to enhance low frequencies.

17. The article of manufacture of claim 13 where the method further comprises adding a delay to the second left and second right signals before the side signal is added to the second left and second right signals to generate the right output signal and the left output signal.

18. An article of manufacture comprising a computer-readable medium having computer-executable instructions for performing a method of spatialization using stereo decorrelation, in an audio system having left and right input channels, the method comprising:
generating decorrelated left and right signals by:
filtering the left input channel using an all-pass filter with a first group delay;
filtering the right input channel using an all-pass filter with a second group delay; the second group delay being different than that of the first group delay;
subtracting the decorrelated left signal from the decorrelated right signal to create a second left signal;
subtracting the decorrelated right signal from the decorrelated left signal to create a second right signal;
generating a side signal by adding the filtered left input channel signal and the filtered right input channel signal;
applying gain to the second left and right signals, and the side signal; where the gain applied to the side signal is greater than the gain applied to either of the second left second right signals;
filtering the second left and second right signals to enhance high frequencies, and filtering the side signal to enhance low frequencies;
adding the side signal to the second left signal to generate a left output signal;
adding the side signal to the second right signal to generate a right output signal; and,
adding a delay to the second left and second right signals before the side signal is added to the second left and second right signals to generate the right output signal and the left output signal.

19. An article of manufacture comprising a computer-readable medium having computer-executable instructions for performing a method of spatialization using stereo decorrelation, in an audio system having left and right input channels, the method comprising:
generating decorrelated left and right signals by:
filtering the left input channel using an all-pass filter with a first group delay;
filtering the right input channel using an all-pass filter with a second group delay; the second group delay being different than that of the first group delay; and,
subtracting the decorrelated right signal from the decorrelated left signal to create a side signal.

20. The article of manufacture of claim 19 where the method further comprises filtering the left and right input channels to enhance high frequencies and filtering the side signal to enhance low frequencies.

21. The article of manufacture of claim 20 where the method further comprises applying gain to the left and right input channels.

22. The article of manufacture of claim 19 where the method further comprises adding a delay to the side signal.

23. The article of manufacture of claim 19 where the method further comprises applying gain to the side signal, where the gain applied to the side signal is greater than the gain applied to either of the left and right input channels.

24. The article of manufacture of claim 20 where the method further comprises:
adding the side signal to the left input channel to recreate a left stereo channel;
inverting the side signal; and,
adding the inverted side signal to the right input channel to recreate a right stereo signal.

25. An article of manufacture comprising a computer-readable medium having computer-executable instructions for performing a method of spatialization using stereo decorrelation, in an audio system having left and right input channels, the method comprising:
generating decorrelated left and right signals by:
filtering the left input channel using an all-pass filter with a first group delay;
filtering the right input channel using an all-pass filter with a second group delay; the second group delay being different than that of the first group delay;
subtracting the decorrelated right signal from the decorrelated left signal to create a side signal;
filtering the left and right input channels to enhance high frequencies and filtering the side signal to enhance low frequencies;
applying gain to the left and right input channels;
adding a delay to the side signal;
applying gain to the side signal, where the gain applied to the side signal is greater than the gain applied to either of the left and right input channels;
adding the side signal to the left input channel to recreate a left stereo channel;
inverting the side signal; and,
adding the inverted side signal to the right input channel to recreate a right stereo signal.

26. A circuit for generating spatialization in an audio system using stereo decorrelation, the circuit comprising:
left and right decorrelators;
a first adder configured to subtract the output of the left decorrelator from the output of the right decorrelator to; the adder having an output connected to a left signal path;
a second adder configured to subtract the output of the right decorrelator from the output of the left decorrelator to; the adder having an output connected to a right signal path;
a third adder configured to add the outputs of the left and right decorrelators; the output of the third adder connected to a side signal path;
a fourth adder configured to add the outputs of the first and third adders; the fourth adder connected to the left signal path and the side signal path; the output of the fourth adder connected to a left output signal path; and,
a fifth adder configured to add the outputs of the second and third adders; the fifth adder connected to the right signal path and the side signal path; the output of the fifth adder connected to a right output signal path.

27. The circuit of claim 26 further comprising a first gain block in the left signal path, a second gain block in the side signal path, and a third gain block in the side signal path.

28. The circuit of claim 26 further comprising a first color filter in the left signal path, a second color filter in the side signal path, and a third color filter in the side signal path.

29. The circuit of claim 26 further comprising a first delay block in the left signal path and a second delay block in the right signal path.

30. A circuit for generating spatialization in an audio system using stereo decorrelation, the system having left and right input channels; the circuit comprising:
left and right decorrelators connected to the left and right input channels, respectively;
a first adder configured to add the output of the left decorrelator and the output of the right decorrelator; the adder having an output connected to a side signal path;
a second adder connected to the left input channel and the side signal path;
the second adder having a left channel output;
a third adder connected to the right input channel and the side signal path;
the third adder having a right channel output.

31. The circuit of claim 30 further comprising a first color filter in the left input channel and a second color filter in the right input channel.

32. The circuit of claim 30 further comprising a third color filter in the side signal path.

33. The circuit of claim 30 further comprising a first gain block in the left input channel, a second gain block in the right input channel and a third gain block in the side signal path.

34. The circuit of claim 30 further comprising a delay block in the side signal path.

35. The circuit of claim 30 further comprising an inverter connected between the side signal path and the third adder.
